(19) United States
(12) Patent Application Publication
(10) Pub. No.: US 2023/0386303 A1
(43) Pub. Date: Nov. 30, 2023

(54) SYSTEMS AND METHODS FOR DISPENSING LOTTERY TICKETS

(71) Applicant: Pollard Banknote Limited, Winnipeg (CA)

(72) Inventors: Nancy Bettcher, Winnipeg (CA); Bryan Greene, Culver City, CA (US); Chongmi Scott, Oxnard, CA (US); Mick Tooley, Essex (GB); Paul Shardlow, Macclesfield (GB)

(21) Appl. No.: 18/304,897

(22) Filed: Apr. 21, 2023

Related U.S. Application Data
(60) Provisional application No. 63/333,336, filed on Apr. 21, 2022.

(51) Int. Cl. G07F 17/32; G07F 17/42

(52) U.S. Cl. CPC G07F 17/329; G07F 17/42

(57) ABSTRACT

Example embodiments relate to systems and methods for dispensing lottery tickets.

### CROSS-REFERENCE TO RELATED APPLICATIONS

This application claims the benefit of U.S. Patent Application No. 63/333,336 which was filed with the United States Patent and Trademark Office on Apr. 21, 2022, the entire contents of which is herein incorporated by reference.

### BACKGROUND

### 1. Field

Example embodiments relate to systems and methods for dispensing lottery tickets.

### 2. Description of the Related Art

Pre-printed lottery tickets are pre-printed tickets authorized by a lottery game ticket manufacturer. These tickets typically offer a cash game prize of a predetermined amount, the prize amount often being covered by a rub or scratch off coating printed or laminated onto a pre-printed surface of the lottery game ticket. Once the game player scratches off the coating, and if the prize amounts match as required by the rules of the game, the lottery game player will win the prize amount printed on the ticket.

Pre-printed lottery tickets are typically purchased at a retail or convenience type of store having a terminal and a display case comprising either a series of bins or plastic holding racks for holding and displaying a supply of pre-printed game tickets. In some situations, when a game player desires to purchase a pre-printed lottery ticket, a sales clerk is required to manually withdraw a requested number of tickets from the ticket storage bin, separate the tickets being sold from the remaining tickets in the ticket pack or book, and tender the tickets to the game player.

### SUMMARY

The inventor notes a number of problems associated with some systems/stores that sell pre-printed lottery tickets. First, security of the pre-printed lottery tickets is a concern. While many of the stores keep the tickets from the general public, there is always a risk theft of improperly stored tickets. Second, there is also a risk that tickets may be lost or misplaced if not properly stored. Third, there is also the possibility a store clerk may miscount a number of tickets provided to a customer. Fourth, manually obtaining tickets can be time consuming. To this end the inventor has invented a new system which assists a store clerk in obtaining and providing to a customer a proper amount of purchased pre-printed lottery tickets while providing a safe and secure location to store pre-printed lottery tickets. However, it is understood the inventive concepts described herein should not be limited to merely pre-printed lottery tickets as the inventive concepts may be applied over a wide range of goods, for example, the purchase and sale of medicine, cigarettes, vape cartridges, alcohol, etc.

In accordance with one example embodiment, a system for dispensing a lottery ticket may include a point of sale system having a point of sale terminal, a point of sale controller configured to control the point of sale system, a point of sale monitor configured to passively listen to the point of sale controller, a ticket dispenser comprised of a plurality of drawers and a plurality of bursters, and a ticket burster controller configured to receive lottery ticket information from the point of sale monitor, store the lottery ticket information, and dispense lottery tickets upon an activation of ticket burster controller by a salesclerk. In at least one example embodiment the plurality of drawers are configured to house a plurality of pre-printed lottery tickets and the plurality of bursters are configured to dispense the plurality of pre-printed lottery tickets from the plurality of drawers.

In example embodiments, a system may be configured to allow the following operations be performed. The system may allow: 1) a salesclerk enter ticket choices into a POS; 2) allow the POS to send ticket choices/count to a ticket management system, via other system(s); 3) have the ticket management system check inventory and send one or more messages back to POS that tickets are available to purchase; 4) allow the sales clerk accept payment and complete one or more transactions on POS; 5) have the POS send purchase information to the ticket management system via other system(s); 6) allow the sales clerk to go to a ticket dispenser controller module and press their lane number on a touchscreen to cause a message to be sent to the ticket management system to validate ticket purchase; 7) allow the ticket dispenser controller to receive confirmation from the ticket management system and display a list of tickets/counts ready to be dispensed; and 8) allow the salesclerk press a button, for example, a “dispense all” button, to dispense tickets.

### BRIEF DESCRIPTION OF THE DRAWINGS

Example embodiments are described in detail below with reference to the attached drawing figures, wherein:

FIGS. 1A and 1B are views of systems for dispensing pre-printed lottery tickets in accordance with an example embodiment;

FIG. 2 is a view of a dispenser for dispensing one or more types of pre-printed lottery tickets in accordance with an example embodiment;

FIGS. 3A and 3B are views of methods of dispensing one or more types of lottery tickets in accordance with an example embodiment;

FIGS. 4A-4C are views of a system for dispensing one or more pre-printed lottery tickets in accordance with an example embodiment;

FIG. 5 is a view of a method of purchasing and dispensing one or more pre-printed lottery tickets in accordance with an example embodiment;

FIG. 6 is a chart illustrating different aspects of a method and system for selling and dispensing pre-printed lottery tickets;

FIG. 7 is an example of an “avocado” sheet in accordance with an example embodiment; and

FIG. 8 is a view of a method in accordance with example embodiments.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to systems and methods for dispensing lottery tickets.

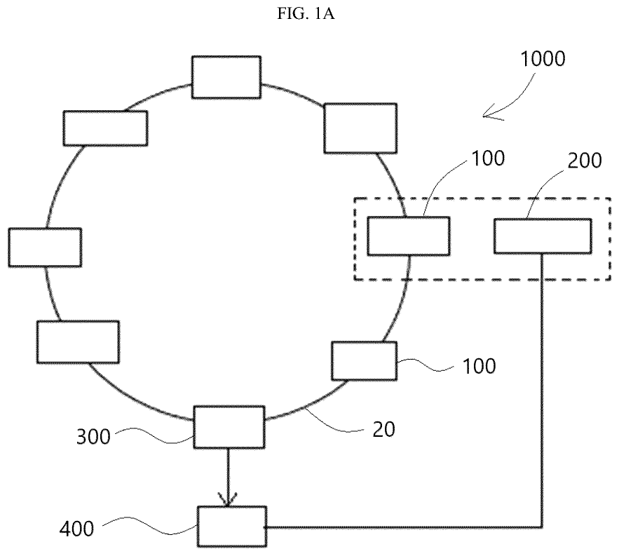

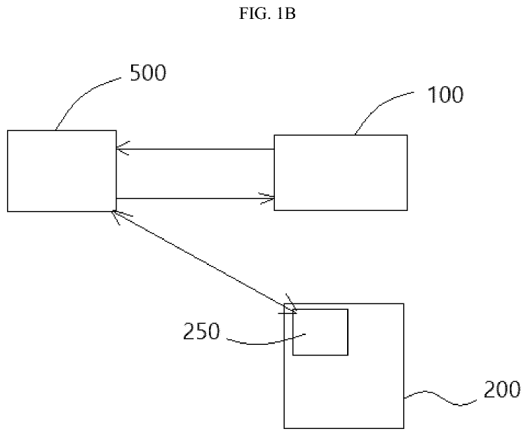

FIG. 1 is a view of a system 1000 in accordance with an example embodiment. As shown in FIG. 1, the system 1000 may include a plurality of point of sale terminals 100 networked to one another through a point of sale network 20. The system 1000 may also include one or more lottery ticket dispensers 200 which may be configured to dispense one or more types of activated pre-printed lottery tickets. In one nonlimiting example embodiment, the system 1000 may be arranged in a retail or convenience store environment, but may be arranged in other environments such as, but not limited to, airports, bus stops, casinos, bars, and restaurants. As such, the system 1000 may be configured in a number of ways in a number of environments. By way of example only, the system 1000 may have a single terminal 100 or several terminals 100. Similarly, system 1000 may have a single lottery ticket dispenser 200 (which may be shared with more than one POS terminal 100) or several lottery ticket dispensers 200.

In FIG. 1, the system 1000 may include a POS system controller 300. In this nonlimiting example embodiment the POS system controller 300 may be of a known type and construction, typically a computer provided with software and stored data in communication with each of terminals 100 through the network 20. In at least one nonlimiting example embodiment the POS system controller 300 may be provided with a stored database of a “price book” containing the identification codes of items offered for sale in the store, as well as the prices for those respective items.

In FIG. 1, the system 1000 may further include a POS system monitor 400 connected to the POS system controller 300. The POS system monitor 400 may be connected to the POS system controller 300 in a number of ways including by wire or wirelessly. In this nonlimiting example embodiment, the POS system monitor 400 is passive, only listening to the traffic on the network 20 and does not transmit data back to the POS system controller 300 or any of the terminals 100.

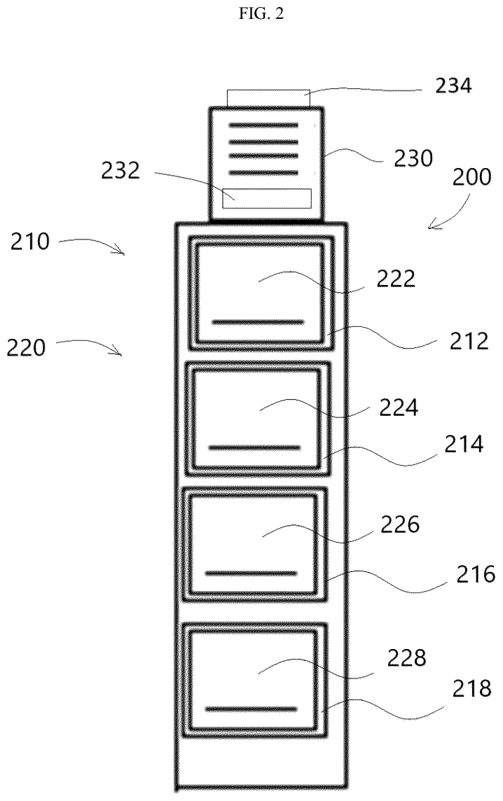

FIG. 2 is a view of a lottery ticket dispenser 200 in accordance with example embodiments. As shown in FIG. 2, one version of the dispenser 200 includes a series of drawers 210 each having a burster 220 for dispensing pre-printed lottery tickets. The example of FIG. 2 shows four drawers 212, 214, 216, and 218 and four bursters 222, 224, 226, and 226 but the invention contemplates dispensers 200 having more or less than four drawers and bursters. In example embodiments, each of the drawers 210 may dispense a same type of pre-printed lottery ticket. On the other hand, each drawer may dispense a particular type of game ticket. For example, drawer 212 may house a first type of pre-printed lottery ticket, drawer 214 may house a second type of pre-printed lottery ticket, drawer 216 may house a third type of pre-printed lottery ticket and drawer 218 may house a fourth type of lottery ticket. The bursters 220 are generally under the control of a ticket burster controller 230. The ticket burster controller 230 may be built into the dispenser 200 or may be a computer, for example, an I-pad, which may connect to the ticket dispenser 200. As explained below, the ticket burster controller 230 may, in one embodiment, have a memory 232 configured to receive purchase information from the POS system monitor 400. In another embodiment, the ticket burster controller 230 does not have a memory to store purchase information but instead is configured to ping a ticket management system to obtain the information it needs. For example, in one embodiment, the POS system monitor 400, by listening to the traffic on the network 20, may determine one or more types of lottery tickets have been purchased. The POS system monitor 400 may forward this information to the ticket burster controller 230 which may store this information in memory 232. In order to cause the ticket dispenser 200 to dispense the proper number and type of tickets the salesclerk must engage an interface 234 of the ticket burster controller 230 to request the tickets be dispensed. For example, the ticket burster controller 230 may have a hard button or may have a touch screen with a soft button that may be pressed. Pressing the button authorizes the ticket burster controller 230 to dispense the number and types of tickets based on the data stored in the memory 232.

It is understood the above description is not intended to limit the invention. For example, FIG. 1B presents a novel system having a POS terminal 100, a ticket dispenser 200, a ticket burster controller 230, and a ticket management system 500. The ticket management system 500 may be a computer having an electronic memory that manages data related to sales of lottery tickets. For example, the ticket management system 500 may have an electronic database which stores and tracks what types (and how many) of tickets are available in various ticket dispensers 200 (one of which is shown in FIG. 1B) which may be under the control of a ticket burster controller 232. The ticket management system 500 may interact either directly or indirectly with the POS system having the POS terminal 100 and/or the ticket burster controller 230 prior to tickets being dispensed from a ticket dispenser 200. Some obvious differences from the system of FIG. 1B and FIG. 1A is that the ticket burster controller 230 of FIG. 1B is not required to have a memory 232 to store purchase information during a transaction but instead is configured to ping a ticket management system 500 to obtain the information it needs after a sale is completed.

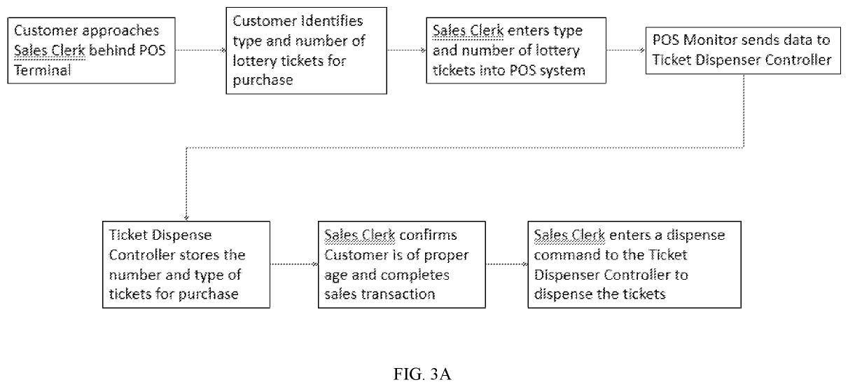

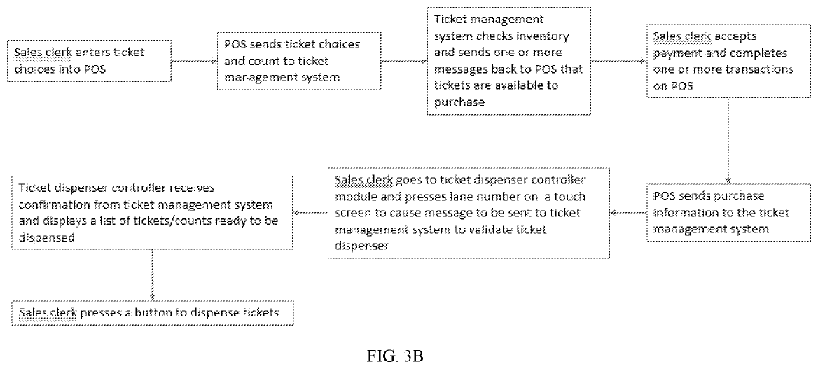

FIG. 3A is a flow chart showing a purchase of one or more lottery tickets using system 1000. As shown in FIG. 3A, the purchase starts with a customer approaching a salesclerk operating a POS monitor 100. The Customer identifies the type and quantity of tickets to be purchased and the salesclerk enters this information into the POS system 1000 via a POS terminal 100. The POS system monitor 400 determines that lottery tickets have been purchased and sends the purchase information, the number and type of lottery tickets for purchase, to the ticket burster controller 230 (in some situations, also called a ticket dispenser controller) which stores this information in memory 232. Once the sales transaction is complete the salesclerk presses a button on the ticket buster controller 230 to cause the ticket burster controller 230 dispense the proper number and type of tickets.

FIG. 3B is another flowchart showing a purchase of one or more lottery tickets. As shown in FIG. 3B, the method may include an operation of a salesclerk entering ticket choices into a POS terminal 100. In FIG. 3B, the POS terminal may send ticket choices/count to a ticket management system 500 either directly or indirectly and the ticket management system 500 may check inventory and send one or more messages back to POS terminal 100 that tickets are available to purchase. The method may further include the steps of allowing the sales clerk accept payment and complete one or more transactions on POS terminal 100. The POS terminal 100 may thereafter send purchase information to the ticket management system 500 directly or indirectly. Afterwards, the sales clerk may go to a ticket dispenser controller module 230 and press their lane number on a touchscreen and display a list of the tickets/counts ready to be dispensed. The sales clerk may then press a button, for example, a “dispense all” button, to dispense tickets a ticket dispenser 200.

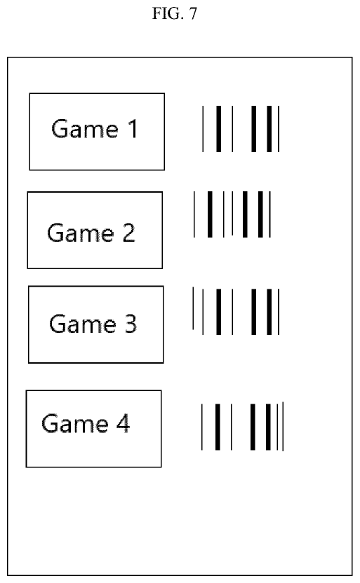

Example embodiments anticipate a number of ways a salesclerk may enter data into the POS terminal 100. In one example embodiment, the salesclerk may manually type in the data into the POS terminal 100 through a keyboard or keypad associated with the POS terminal 100. In another embodiment, the salesclerk may have a “avocado sheet”, an example of which is shown in FIG. 7, with bar codes associated with each type of game available for purchase. In this embodiment, the salesclerk may simply use a hand held bar code reader to read the bar codes as is known in the art.

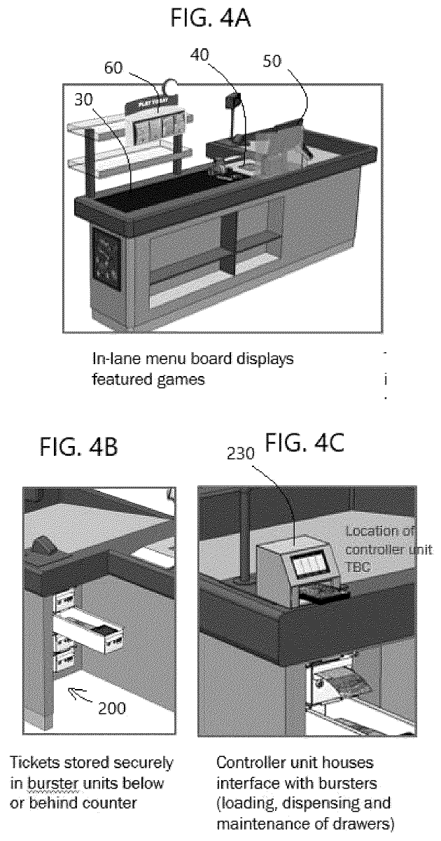

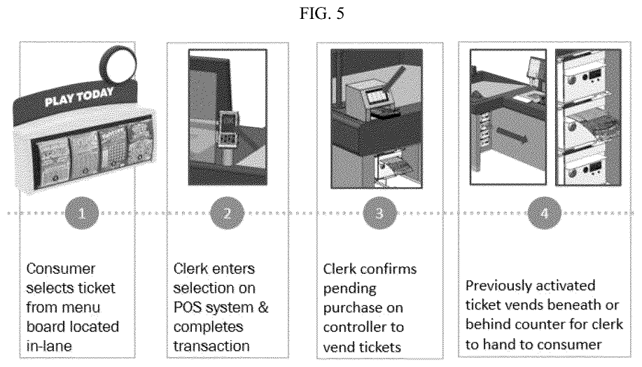

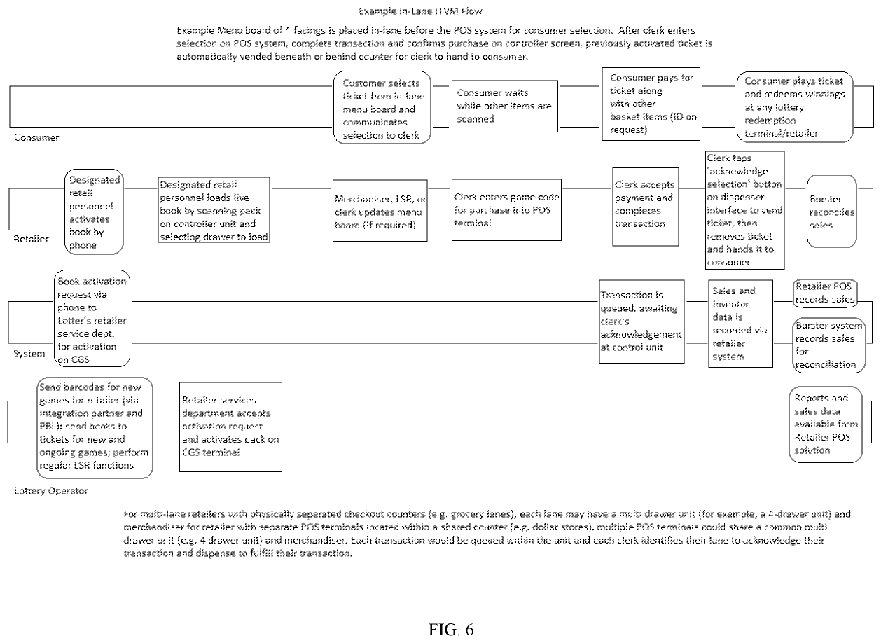

By way of example only, FIGS. 4A, 4B, and 4C illustrate an example of system 1000 implemented in a retail store. As shown in FIG. 4A, a POS station may include a belt 30 to allow articles to move from one end of the station to another end of the station, a scanner 40 to scan a bar code on the articles, a monitor 50, and a menu board 60 to display featured games. Pre-printed lottery tickets may be housed in the dispenser 200 which may be arranged under a counter as shown in FIGS. 4B and 4C. The ticket burster controller 230, which interfaces and controls the bursters, is accessible by the salesclerk. In this nonlimiting example embodiment, a customer may inspect the menu board 60, inform the salesclerk as to the type an number of tickets for purchase, the salesclerk may thereafter enter the selection in the POS system and complete the transaction. The clerk may thereafter confirm the purchase of the tickets on the ticket burster controller 230 to dispense the tickets. Afterwards, the clerk may hand the tickets to the customer.

From a conceptual viewpoint, the ticket burster controller 230 (and/or the ticket management system 500) may have the memory 232 which may receive and store ticket information. The ticket burster controller 230 (and/or the ticket management system 500) may also have a lookup table encoded in a memory chip which allows the ticket burster controller 230 to issue commands to the appropriate ticket burster. For example, the lookup table may resemble the following:

| Ticket Burster ID | Type of ticket |
|---|---|
| 222 | 1 |
| 224 | 2 |
| 226 | 3 |
| 228 | 1 |

In this particular nonlimiting example embodiment, the table allows a ticket burster controller 230 to know what bursters may be operated to dispense a certain type of ticket. For example, in the instant example, bursters 222 and 228 may dispense a first type of ticket, burster 224 may dispense a second type of ticket, and burster 226 may dispense a third type of ticket.

As a nonlimiting example of using the above lookup table, POS system monitor 400 may detect that a customer has ordered three type 1 tickets and two type 2 tickets and this information may be sent to the ticket burster controller 230 and stored in memory 232. Upon activation of the ticket burster controller 230 by the salesclerk at the end of a transaction, the ticket burster controller 230 may use this information to control ticket burster 222 to dispense three type 1 tickets and thereafter control ticket burster 224 to dispense two tickets. In the event the burster 222 cannot dispense three tickets (for example, drawer 212 is empty) the ticket burster controller 230 may instruct ticket burster 228 to dispense the proper number of type 1 tickets.

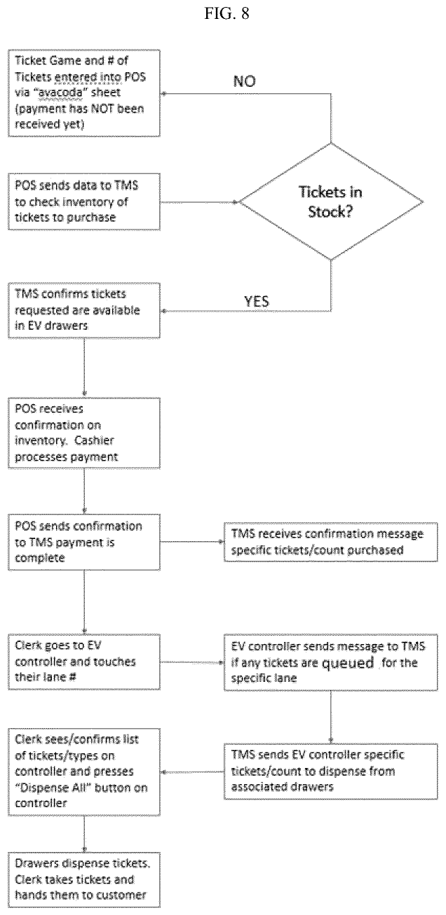

FIG. 8 is an example of another method for dispensing lottery tickets. As shown in FIG. 8, the method begins with ticket games and a number of tickets being entered into a POS system. The type and number of tickets may be entered manually, as through a keyboard, or through an “avocado sheet” using a scanner, for example, a fixed or handheld scanner. It is noted that payment may not have been received at this time. The POS system may send the purchase data (type and number of tickets for purchase) to a ticket management system which checks inventory of tickets to purchase If the tickets are not in stock the ticket management system informs the POS system the tickets are not available otherwise the ticket management system confirms the tickets requested are available, for example, in drawers controlled by a ticket dispenser controller. After the POS receives confirmation that the tickets are available, the sales clerk processes payment and the POS system sends confirmation to the ticket management system payment is complete. The sales clerk thereafter may engage a ticket dispenser controller which may have a display, for example a touch screen, allowing selection of the sale clerk's lane. The sales clerk may select their lane and the ticket dispenser controller may there after send a message to the ticket management system to see if any tickets are queued for the selected lane. The ticket management system may send the ticket dispenser controller the specific type and number of tickets to dispense from its associated drawer and the clerk may see and confirm the type of number of tickets for dispensing. The clerk may thereafter press a button (for example, a “dispense all” button) which may be available on or associated with the ticket dispenser controller. Pressing the button will cause the drawers to dispense the tickets which may be taken by the clerk and given to the customer.

In example embodiments it is anticipated bursters may be shared by multiple POS terminals. In other words, multiple POS systems/terminals may communicate to a single ticket dispenser controller which queues the transactions and dispenses tickets after clerk confirms the transaction on the ticket dispenser controller.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described

What I claim is:

1. A system comprising:
a point of sale system having at least one point of sale terminal;
a plurality of drawers;
a plurality of ticket bursters configured to dispense lottery tickets from the plurality of drawers;
a ticket burster controller configured to control the plurality of ticket bursters; and
a ticket management system configured to receive lottery ticket purchase information from the point of sale system, determine if a number and type of lottery of ticket is available in the plurality of drawers and inform the point of sale system whether the number and type of lottery ticket is available in the plurality of drawers, wherein the point of sale system is configured to inform the ticket management system that a sale of the tickets is complete, the ticket burster controller is configured to ping the ticket management system regarding tickets queued for dispensing, and the ticket management system is configured to respond to the ping by sending specific ticket and count information to the ticket burster controller, and the ticket burster controller is configured to control the plurality of burster to dispense the specific type and number of tickets upon activation of a button by a sales clerk.

2. The system of claim 1, wherein the ticket burster controller is configured to communicate with multiple POS systems and terminals and is further configured to queue a plurality of transactions and dispense tickets after a clerk confirms transaction on the ticket burster controller.

3. A ticket dispenser comprising:
at least one drawer having an associated burster to dispense tickets from the at least one drawer; and
a ticket burster controller configured to control the burster, wherein the ticket burster controller has a memory to store purchase information obtained from a POS system and an interface having a button that upon being pressed by a sales clerk causes the ticket burster controller to control the burster to dispense the tickets.

4. The ticket dispenser of claim 3, wherein the at least one drawer is a plurality of drawers each having a ticket burster and the ticket burster controller controls the ticket bursters of each of the plurality of drawers to dispense tickets upon the button of the interface being pressed.

5. The ticket dispenser of claim 3, wherein the button is a soft button.

6. The ticket dispenser of claim 3, wherein the button is a hard button.

7. A method of dispensing lottery tickets comprising:
identifying a type and number of lottery tickets for purchase;
entering the type and number of lottery tickets into a POS system;
sending data including the type and number of lottery tickets to a ticket dispenser controller;
storing the data in a memory of the ticket dispenser controller;
entering a dispense command to the ticket dispenser controller to dispense the tickets.

8. The method of claim 7, wherein the ticket dispenser controller controls a plurality of bursters associated with a plurality of drawers.

9. The method of claim 7, wherein the dispense command is initiated by a sales clerk.

10. The method of claim 9, wherein the dispense command is initiated when the sales clerk presses one of a soft and hard button.
